(19) United States
(12) Patent Application Publication
(10) Pub. No.: US 2002/0063763 A1
(43) Pub. Date: May 30, 2002

(54) Apparatus and method for removing air bubbles from an ink jet printhead

(76) Inventors: David Allen Mantell, Rochester, NY (US); Lisa A. Delouise, Rochester, NY (US); Andrew W. Hays, Fairport, NY (US)

Correspondence Address: Lawrence Harbin, McIntyre Harbin & King, One Massachusetts Avenue, Suite 330, Washington, DC, 20001, US

(21) Appl. No.: 09/725,295

(22) Filed: Nov. 29, 2000

(51) Int. Cl. B41J 2/19

(52) U.S. Cl. 347/92

(57) ABSTRACT

A microchannel fluidic device, such as an ink jet printhead, includes an fluid reservoir for receiving ink or other fluid from a supply. The reservoir has an inlet in communication with the supply, and an outlet. A plurality of nozzles are in fluid communication with the reservoir for delivering ink or fluid from the reservoir. The outlet of the reservoir is constructed and arranged such that air bubbles in the reservoir are ejected by differential pressure between the inlet and outlet, rather than being forced through nozzles. An overflow reservoir captures fluid ejected from the outlet during priming operations thereby to reduce waste, to enable treatment of the fluid, and/or to recirculate the fluid.

### FIELD OF THE INVENTION

This invention relates to microchannel fluidic devices and, more particularly, to a method and apparatus for removing air bubbles from an ink reservoir of an ink jet printhead.

### BACKGROUND OF THE INVENTION

With reference to FIG. 1, a conventional ink jet printhead, generally indicated at 10, includes ink inlets 12, an ink reservoir 14, and a plurality of nozzles 16. When large amounts of air are trapped in the ink reservoir 14, the air bubbles 18 can restrict the ink flow to the individual nozzles 16. This can cause individual nozzles 16 to fail to print drops of ink. Priming is the operation in which ink and hopefully the air bubble as well are removed from the printhead through a differential pressure, usually between the reservoir 14 and the nozzles 16. Priming through the nozzles 16 requires a high differential pressure and can consume a considerable amount of ink. Given that the ink supply sold with an ink cartridge is limited or that the ink is sold in small replaceable units, priming for bubble maintenance can be very costly for users. The main reason that so much ink is wasted is that the air bubble must be forced out of its preferred location in the reservoir and induced by differential pressure between an inlet and discharge path and deformation of the air bubbles in the nozzle region of the printhead. The small size of the microchannels necessitates the use of aggressive forces to move and/or deform air bubbles through inlet and outlet ports.

Accordingly, there is a need to move air bubbles from reservoirs and channels of microchannel fluidic devices, such as an ink jet printhead, with minimal loss of ink or other fluid.

### SUMMARY OF THE INVENTION

An object of the present invention is to fulfill the need referred to above. In accordance with the principles of the present invention, this objective and other objects, as applied in the inkjet printer arts, are obtained by providing an ink jet printhead including an fluid reservoir for receiving ink from a supply of ink. The reservoir has an inlet constructed and arranged to communicate with the supply of ink, and an outlet. A plurality of nozzles are in fluid communication with the reservoir for delivering ink from the reservoir in the form of a series of droplets, which are then deposited on the substrate. The outlet of the reservoir is constructed and arranged such that air bubbles in the reservoir are primed out of the reservoir through the outlet when a small differential pressure is applied to inlet and outlet ports.

In accordance with another aspect of the invention, a method is provided for removing a bubble from an fluid reservoir, such as a fluid reservoir of an ink jet printhead. The method provides a reservoir for receiving a fluid from a supply. The reservoir has an inlet constructed and arranged to communicate with the supply, and an outlet. A plurality of nozzles or discharge ports are provided in fluid communication with the reservoir for delivering the fluid from the reservoir. Fluid is primed through the reservoir such that air bubbles in the fluid reservoir are moved out of the reservoir through the outlet and not through the nozzles or discharge ports.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. For purposes of illustration, the disclosure is directed to an ink reservoir of an ink jet printhead but is not limited thereto. The invention may be deployed in other microchannel fluidic devices requiring removal of air bubbles.

### BRIEF DESCRIPTION OF THE DRAWINGS

Reference is made to the attached drawings, wherein elements having the same reference numeral designations represent like elements throughout and wherein:

FIG. 1 is a schematic illustration of the front of a conventional ink jet printhead containing air bubbles in a reservoir thereof to illustrate an environment in which the invention may be deployed.

FIG. 2 is a schematic illustration of the front of a printhead system for air bubble removal, provided in accordance with the principles of a first embodiment of the invention.

FIG. 3 is a schematic illustration of the front of a printhead system for air bubble removal, provided in accordance with the principles of a second embodiment of the invention.

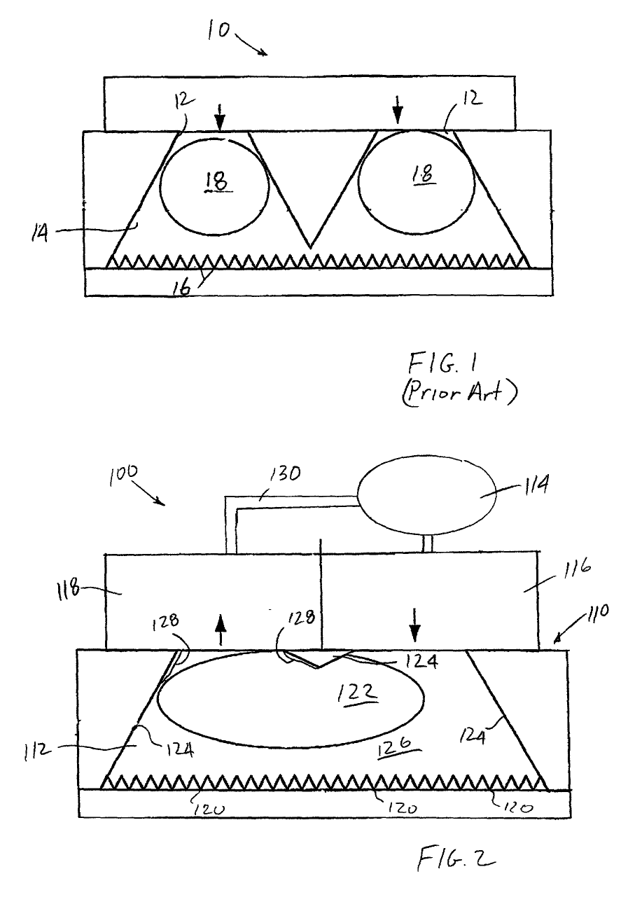

### DESCRIPTION OF ILLUSTRATIVE EMBODIMENTS

Referring to FIG. 2, an ink jet printhead system 100 is shown, and provided in accordance with principles of a first embodiment of the present invention where ink is primed through the reservoir rather than through the nozzle channels. For illustrative purposes, the invention is being described in connection with an in jet printhead, it being understood that various aspects of the invention described herein have application in other microchannel fluidic devices.

The system 100 includes an ink jet printhead 110. The printhead 110 includes an fluid reservoir 112 for receiving ink from a supply of ink 114. The reservoir 112 has an inlet 116 in communication with the supply of ink 114, and an outlet 118 separated from and adjacent to the inlet 116. A plurality of nozzles 120 are in fluid communication with the reservoir 112 for delivering a fluid, e.g., ink, from the reservoir 112. The nozzles 120 are in spaced relation with respect to the inlet 116 and outlet 118 of the reservoir 112, with the nozzles being near the bottom of the reservoir and the inlet 116 and outlet 118 being near the top of the reservoir. Thus, in the disclosed embodiment the outlet 118 of the reservoir is constructed and arranged such that an air bubble 122 in the reservoir 112, rather than being ejected from nozzles 120, is primed out of the reservoir through the outlet 118 by inducing a differential pressure between the inlet and outlet.

The printhead 110 may be of the monochrome type or of the segmented color type. Employing the reservoir outlet 118 in the segmented color printhead will increase in ease as the printhead size increases. For example, a 640 jet three color printhead would have twice the area for connecting ink inlets as a 320 jet printhead, leaving enough room for the ink outlets 118.

In larger printheads, there are typically dividers in the ink reservoir to add structural stability to the reservoir, which typically is formed by etching a thin silicon wafer. Normally, the dividers may prevent air bubbles from being primed through an ink outlet. Thus, in accordance with a related application filed of even date and entitled SUPPORT STRUCTURE FOR LARGE CHANNEL PLATES OF AN INK JET PRINTHEAD in the names David Allen Mantell, Lisa A. DeLouise, and James F. O'Neill and assigned to the same assignee hereof the reservoir 112 includes support structure 124 constructed and arranged to provide support to the walls 124 of the reservoir 112 while permitting ink to move across a region 126 of the reservoir 112. With this structure, air bubbles 122 in the reservoir 112 can move in a generally unobstructed manner across the reservoir 112 to the outlet 118. The support structure 124 can be defined by etching the conventional dividers.

One of the main advantages of priming air bubbles 122 through the reservoir 112 is that the bubbles will naturally sit near the outlet 118 due to fluid flow from inlet 116 during printing. Therefore the bubbles 122 need not be forced there by a large differential pressure. Thus, far less pressure is needed to move an air bubble 122 through the ink outlet 118. Hence, priming will require less ink to be removed from the reservoir through the outlet 118.

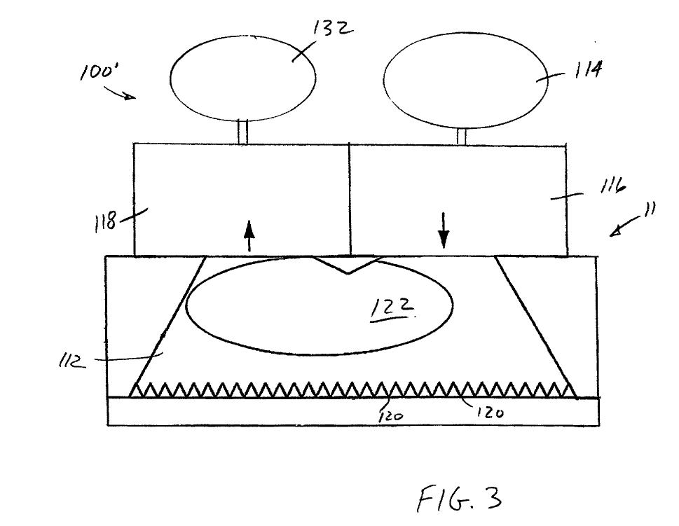

In the embodiment of FIG. 2, during priming, ink exiting the outlet 118 is directed back to the supply of ink 114 via a fluid connection 130 between the outlet 118 and the supply of ink 114. Alternatively, in the system 100′ shown in FIG. 3, an ink collection structure 132 can be connected with the outlet 118 to collect ink during priming of the reservoir 112. In either embodiment, discharging or recycling the ink is far less wasteful and thus allows more priming operations than is conventionally permitted due to cost considerations. Circulating the ink through the reservoir also improves thermal management of the system 100.

To promote the attraction of air bubbles 122 to the outlet 118 and reduce the pressure necessary to remove the air bubbles 122, a hydrophobic coating 128 can be applied to surfaces defining the outlet 118. A type of hydrophobic coating suitable for this application is, for example, polydimethysiloxane (PDMS) elastomer. Another example of a suitable hydrophobic coating is sold under the tradename RAIN-X, which is produced by UNELKO Corporation, Scottsdale, AZ.

It can be appreciated that the invention is applicable to silicon channel plates, plastic fluid manifold type structures, and many other devices, materials, and structures, including plastics, metal, or other materials. In addition, fluid can be treated during circulation when removed from the reservoir. Such treatment may include filtering or de-gassing, scanning for contaminates or degradation.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An microchannel fluidic device comprising:
a reservoir for receiving fluid from a supply, the reservoir having an inlet constructed and arranged in communication with the supply, and an outlet, and
a plurality of nozzles in fluid communication with the reservoir for delivering fluid from the reservoir,
the outlet of the reservoir being constructed and arranged such that air bubbles in the reservoir are removed from the reservoir by differential pressure applied at an inlet and outlet.

2. The microchannel fluidic device of claim 1, wherein the reservoir includes nozzles for an ink jet printhead to deliver droplets of inks to a substrate, the outlet being disposed near a top of the reservoir and the nozzles being disposed near a bottom of the reservoir.

3. The microchannel fluidic device of claim 2, wherein the outlet is adjacent to the inlet.

4. The microchannel fluidic device of claim 2, wherein the printhead is monochromatic.

5. The microchannel fluidic device of claim 2, wherein the printhead is a segmented color printhead.

6. The microchannel fluidic device of claim 1, wherein the reservoir includes support structure constructed and arranged to provide support to walls of the reservoir while permitting fluid and air bubbles to move across a region of the reservoir.

7. The microchannel fluidic device of claim 1, further comprising a hydrophobic coating on surfaces defining the outlet for attracting air bubbles.

8. The microchannel fluidic device of claim 1, in combination with an ink collection structure, the outlet of the reservoir being fluidly connected with the ink collection structure.

9. The microchannel fluidic device of claim 1, in combination with the Supply of ink and further comprising a connection fluidly connecting the outlet of the reservoir with the supply of ink.

10. A method of removing a bubble from a fluid reservoir of a microchannel fluidic device, the method comprising:
providing a reservoir for receiving fluid from a supply, the reservoir having an inlet constructed and arranged to be in communication with the supply, and an outlet,
providing a plurality of nozzles in fluid communication with the reservoir for delivering a fluid from the reservoir, and
priming the fluid through the reservoir such that air bubbles in the reservoir move out of the reservoir by way of differential pressure between the inlet and outlet.

11. The method of claim 10, wherein the reservoir is provided such that the outlet is spaced from nozzles with the outlet being disposed near a top of the reservoir and the nozzles being disposed near a bottom of the reservoir.

12. The method of claim 11, wherein the outlet is provided adjacent to the inlet.

13. The method of claim 10 wherein the reservoir is provided with support structure constructed and arranged to provide support to walls of the reservoir while permitting fluid and air bubbles to move across a region of the reservoir during the priming step.

14. The method of claim 10, further providing a hydrophobic coating on surfaces defining the outlet for attracting air bubbles.

15. The method of claim 10, further including collecting the fluid as it exits the outlet.

16. The method of claim 10, further including directing the fluid to the supply as the flluid exits the outlet.
